(19) United States
(12) Patent Application Publication
(10) Pub. No.: US 2010/0142921 A1
(43) Pub. Date: Jun. 10, 2010

(54) APPARATUS AND METHOD FOR TRANSMITTING/RECEIVING DIGITAL BROADCASTING

(75) Inventors: Sangwoo AHN, Daejon (KR); Jeho NAM, Seoul (KR); Moon-Kyun OH, Daejon (KR); Sang-Kwon SHIN, Daejon (KR); Won-Sik CHEONG, Daejon (KR); Hyon-Gon CHOO, Daejon (KR); Jooyoung LEE, Seoul (KR); Jin-Woo HONG, Daejon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejon (KR)

(21) Appl. No.: 12/633,355

(22) Filed: Dec. 8, 2009

(30) Foreign Application Priority Data
Dec. 8, 2008 (KR) 10-2008-0124315
Apr. 24, 2009 (KR) 10-2009-0036009

(51) Int. Cl. H04N 5/913; H04N 7/167

(52) U.S. Cl. 386/94; 725/28; 725/142; 725/39; 386/E05.004

(57) ABSTRACT

This research discloses a digital broadcasting contents transmitting/receiving apparatus that can quickly and easily purchase broadcasting contents, and a method thereof. The apparatus for receiving a digital broadcasting includes: a broadcasting contents receiver configured to receive a broadcasting content and first program protection information (PPI) including distribution scope information of the broadcasting content; a content storage configured to store the received broadcasting content; a purchase requester configured to transmit purchase request information according to a purchase request of a user for the stored broadcasting content; and a PPI controller configured to replace the first PPI with second PPI transmitted to the broadcasting contents receiver in response to the purchase request and including information on a changed distribution scope of the broadcasting content for which the purchase request is made.

### CROSS-REFERENCES TO RELATED APPLICATIONS

The present invention claims priority of Korean Patent Application Nos. 10-2008-0124315 and 10-2009-0036009, filed on Dec. 8, 2008, and Apr. 24, 2009, respectively, which are incorporated herein by reference in their entirety.

### BACKGROUND OF THE INVENTION

1. Field of the Invention

The present invention relates to a digital broadcasting contents transmitting/receiving apparatus that can quickly and easily purchase broadcasting contents, and a method thereof.

2. Description of Related Art

Digital broadcasting using digital signals has many advantages compared to analog broadcasting. Such digital broadcasting may be characterized by multiple channels, high quality, and multiple functions. Due to the advancement in multiplexing technology, digital broadcasting can multiplex and transmit video, speech and data simultaneously regardless of their contents and volume. Also, since interactive service through modem is possible, digital broadcasting can provide viewers, or users, with multimedia services of a quality higher than that of conventional analog broadcasting.

Digital broadcasting has made it convenient to store, edit, and distribute broadcasting contents, but at the same time digital broadcasting has a problem in that it is easy to illegally copy and distribute broadcasting contents. An example is illegal distribution of many broadcasting contents produced in domestic and overseas countries through the

Internet, particularly, through a Peer-to-Peer (P2P) service. In the overseas countries, broadcasting contents are produced in the form of Digital Versatile Disk (DVD) without permission and illegally distributed or sold.

To resolve these problems, there is an attempt of transmitting Program Protection Information (PPI) along with digital broadcasting contents to restrict illegal copying and distribution of the broadcasting contents and thereby protect a copyright and secure private use of a user. The PPI forces a digital broadcasting contents receiving apparatus to encrypt and store broadcasting contents so that the digital broadcasting contents could not be illegally distributed out of the digital broadcasting contents receiving apparatus.

Meanwhile, it is expected that the digital broadcasting will be accelerated and the distribution of broadcasting contents at the market will occur actively. Broadcasting contents can be copied and distributed without infringing the copyright only when they are sold. At present, purchasing a broadcasting content requires a separate procedure of acquiring permission from the copyright holder of the broadcasting content. Also, to download a broadcasting content after buying the broadcasting content, it takes a considerable time according to the file volume of the broadcasting content and the transmission bandwidth of the Internet.

### SUMMARY OF THE INVENTION

An embodiment of the present invention devised to overcome the above-mentioned problems is directed to providing a digital broadcasting contents transmitting/receiving apparatus that can quickly and easily purchase broadcasting contents, and a method thereof.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an apparatus for receiving a digital broadcasting, which includes: a broadcasting contents receiver configured to receive a broadcasting content and first program protection information (PPI) including distribution scope information of the broadcasting content; a content storage configured to store the received broadcasting content; a purchase requester configured to transmit purchase request information according to a purchase request of a user for the stored broadcasting content; and a PPI controller configured to replace the first PPI with second PPI transmitted to the broadcasting contents receiver in response to the purchase request and including information on a changed distribution scope of the broadcasting content for which the purchase request is made.

In accordance with another aspect of the present invention, there is provided an apparatus for transmitting a digital broadcasting, which includes: a broadcasting contents transmitter configured to transmit a broadcasting content and first PPI including distribution scope information of the broadcasting content; and a PPI generator configured to generate second PPI to be transmitted by the broadcasting contents transmitter and including information on a changed distribution scope of the broadcasting content for which a purchase request is made by a user, in response to the purchase request of the user for the broadcasting content stored in a digital broadcasting contents receiving apparatus.

In accordance with another aspect of the present invention, there is provided an method for receiving a digital broadcasting, which includes: receiving a broadcasting content and first PPI including distribution scope information of the broadcasting content; storing the received broadcasting content; transmitting purchase request information according to a purchase request of a user for the stored broadcasting content; receiving second PPI transmitted and transmitted in response to the purchase request and including information on a changed distribution scope of the broadcasting content for which the purchase request is made; and replacing the first PPI with the second PPI.

In accordance with another aspect of the present invention, there is provided a method for transmitting a digital broadcasting, which includes: transmitting a broadcasting content and first PPI including distribution scope information of the broadcasting content; generating second PPI including information on a changed distribution scope of the broadcasting content for which a purchase request is made by a user, in response to the purchase request of the user for the broadcasting content stored in a digital broadcasting contents receiving apparatus; and transmitting the second PPI.

### BRIEF DESCRIPTION OF THE DRAWINGS

FIG. 1 is a conceptual diagram illustrating a purchase of a broadcasting content in accordance with an embodiment of the present invention.

FIG. 2 is a block view illustrating a digital broadcasting contents receiving apparatus 103 in accordance with an embodiment of the present invention.

FIG. 3 is a block view illustrating a digital broadcasting contents transmitting apparatus 101 in accordance with an embodiment of the present invention.

FIG. 4 is a flowchart describing a method for receiving a digital broadcasting in accordance with an embodiment of the present invention.

FIG. 5 is a flowchart describing a method for transmitting a digital broadcasting in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

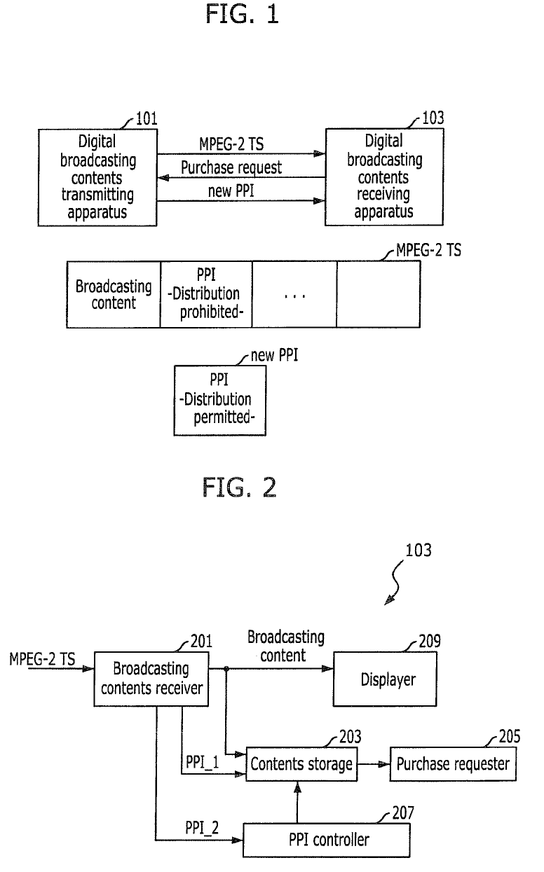

FIG. 1 is a conceptual diagram illustrating a purchase of a broadcasting content in accordance with an embodiment of the present invention.

A digital broadcasting contents transmitting apparatus 101 can transmit a broadcasting content and Program Protection Information (PPI) corresponding to the broadcasting content in the form of Moving Picture Experts Group (MPEG) 2 transport stream (TS). Each MPEG-2 transport stream may include the broadcasting content, the PPI, and other information needed for digital broadcasting. The PPI includes information on the distribution scope of the broadcasting content, and the distribution scope of the broadcasting content is decided based on the distribution scope information of the broadcasting content. For instance, as shown in FIG. 1, the PPI may include information prohibiting external distribution of the broadcasting content to protect the copyright holder of the broadcasting content and secure the private use of a digital broadcasting viewer. In this case, the external distribution of the broadcasting content is forbidden.

A digital broadcasting contents receiving apparatus 103 receives MPEG-2 transport stream and stores a broadcasting content. When there is a purchase request for the stored broadcasting content from a user, the digital broadcasting contents receiving apparatus 103 transmits the purchase request of the user to the digital broadcasting contents transmitting apparatus 101.

The digital broadcasting contents transmitting apparatus 101 transmits a new PPI for the broadcasting content for which the user made a purchase request to the digital broadcasting contents receiving apparatus 103 in response to the purchase request of the user. The new PPI according to the purchase request of the user includes information on the changed distribution scope of the broadcasting content to be purchased. For example, as illustrated in FIG. 1, the new PPI according to the purchase request may include information permitting external distribution of the broadcasting content, which is different from the existing PPI.

As the digital broadcasting contents receiving apparatus 103 replaces the existing PPI with the new PPI according to the above purchase request, the user may copy the requested broadcasting content and distribute it outside.

To sum up, the technology of the present invention can pre-store a received broadcasting content and the user can make a purchase request for the stored broadcasting content. Then, as the digital broadcasting contents receiving apparatus 103 receives the new PPI including information on the changed distribution scope of the broadcasting content to be purchased according to the purchase request of the user and replaces the existing PPI with the new PPI, the purchase is made and the user can copy and distribute the purchased broadcasting content. After all, the technology of the present invention quickly and easily purchase the broadcasting content without going through a separate download procedure by receiving a PPI again and acquiring permission for copying and distributing of the broadcasting content from a broadcasting content provider or a copyright holder. Meanwhile, the payment for the purchase of a broadcasting content may be made according to general electronic commerce procedures.

FIG. 2 is a block view illustrating the digital broadcasting contents receiving apparatus 103 in accordance with an embodiment of the present invention. Referring to FIG. 2, the digital broadcasting contents receiving apparatus 103 includes a broadcasting contents receiver 201, a content storage 203, a purchase requester 205, and a PPI controller 207.

The broadcasting contents receiver 201 receives a broadcasting content and first PPI (PPI_1) corresponding to the broadcasting content. The first PPI (PPI_1) includes the distribution scope information of the broadcasting content, which is described above with reference to FIG. 1. The broadcasting content and the first PPI (PPI_1) may be transmitted in the form of MPEG-2 transport stream as described in the above, and the broadcasting contents receiver 201 can demodulate and decode the MPEG-2 transport stream.

The content storage 203 stores the broadcasting content received in the broadcasting contents receiver 201. The content storage 203 stores the received broadcasting content in the form of MPEG-2 transport stream or in a Digital Video Broadcasting (DVB) file format, ISO Base Media file format and the like. Also, the content storage 203 may store the first PPI (PPI_1) together.

A user may make a purchase request for a broadcasting content stored in the content storage 203, and the purchase requester 205 transmits the purchase request information according to the purchase request to the digital broadcasting contents transmitting apparatus 101. The digital broadcasting contents transmitting apparatus 101 transmits second PPI

(PPI_2) corresponding to the purchase-requested broadcasting content to the digital broadcasting contents receiving apparatus 103 in response to the purchase request.

The PPI controller 207 replaces the first PPI (PPI_1) for the purchase-requested broadcasting content with the second PPI (PPI_2).

The second PPI (PPI_2) includes information on a changed distribution scope of the purchase-requested broadcasting content, as described above with reference to FIG. 1. For example, the first PPI (PPI_1) for the purchase-requested broadcasting content may include information prohibiting external distribution of the purchase-requested broadcasting content, and the second PPI (PPI_2) for the purchase-requested broadcasting content may include information permitting external distribution of the purchase-requested broadcasting content.

As the PPI controller 207 replaces the first PPI (PPI_1) for the purchase-requested broadcasting content with the second PPI (PPI_2), the distribution scope of the purchase-requested broadcasting content is changed and the purchase-requested broadcasting content may be distributed outside.

Meanwhile, according to an embodiment of the present invention, the purchase request may be executed based on Electronic Program Guide (EPG). Digital broadcasting provides an EPG service to provide viewers with a broadcasting schedule of broadcasting contents and brief summary of the broadcasting contents.

Users may select a broadcasting content to purchase based on the EPG. To be specific, the broadcasting contents receiver 201 further receives a program identifier (ID), which is an identifier of a broadcasting content. A purchase is requested as a user transmits a program identifier corresponding to the broadcasting content the user wants to purchase to a broadcasting contents provider, which is the digital broadcasting contents transmitting apparatus 101.

Hereafter, PPI used in a terrestrial digital broadcasting where broadcasting contents are provided in real-time according to a broadcasting schedule will be described in detail.

PPI may be formed as shown in the following Table 1 based on a Redistribution Control (RC) descriptor of the Advanced Television System Committee (ATSC).

TABLE 1

| | No. | |
|---|---|---|
| | of | |
| Syntax | Bits | Format |
| program_protection_information( ) { | | |
| Version | 8 | 0Xaa |
| Redistribution_control_code | 2 | uimsbf |
| if( Redistribution_control_code == ‘01’) { | | |
| allowed_max_resolution | 2 | uimsbf |
| holdback_time | 3 | uimsbf |
| allowed_length | 3 | uimsbf |
| } | | |
| Redistribution_area | 1 | uimsbf |
| Reserved | 5 | bslbf |
| ppi_signature | 320 | uimsbf |
| } | | |

‘Version’ represents version information of PPI, and ‘redistribution_control_code’ represents distribution control information of a broadcasting content. For example, the value of ‘redistribution_control_code’ being ‘00’ in the first PPI (PPI_1) indicates that the external distribution of the broadcasting content is prohibited. The value of ‘redistribution_control_code’ of the second PPI (PPI_2) transmitted in response to the purchase request being ‘11’ in the first PPI (PPI_1) indicates that the external distribution of the broadcasting content may be permitted. Also, the external distribution scope may be variably determined according to the value of ‘redistribution_control_code’.

‘Redistribution_area’ represents distribution scope information of a broadcasting content, and ‘ppi_signature’ represents signature information for verifying the integrity of the PPI and a program identifier. PPI may conform to terrestrial broadcasting program PPI transmission/reception specification established by the Telecommunications Technology Association (TTA).

Meanwhile, the digital broadcasting contents receiving apparatus 103 according to an embodiment of the present invention may further include a displayer 209, which restores and outputs the received broadcasting content.

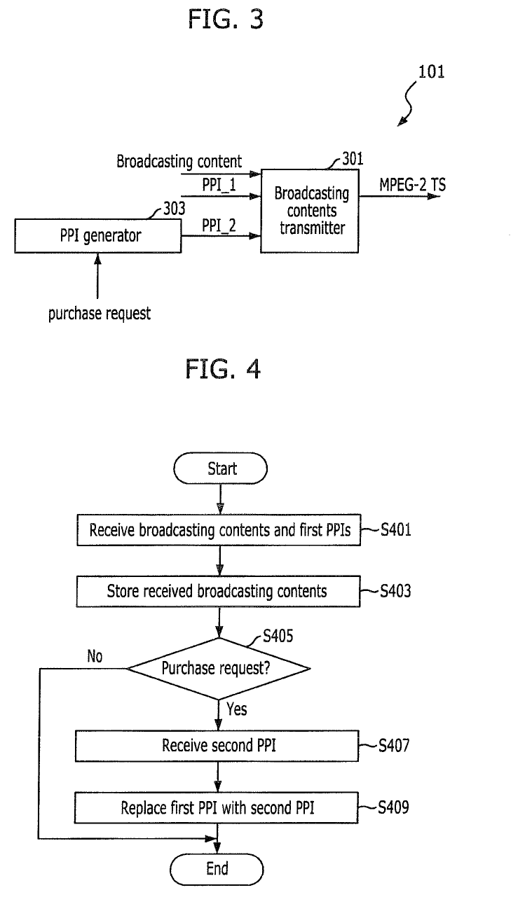

FIG. 3 is a block view illustrating a digital broadcasting contents transmitting apparatus 101 in accordance with an embodiment of the present invention. Referring to FIG. 3, the digital broadcasting contents transmitting apparatus 101 includes a broadcasting contents transmitter 301 and a PPI generator 303.

The broadcasting contents transmitter 301 transmits an inputted broadcasting content and first PPI to the digital broadcasting contents receiving apparatus 103. Herein, the broadcasting contents transmitter 301 may transmit the broadcasting content and the first PPI (PPI_1) in the form of MPEG-2 transport stream. The digital broadcasting contents receiving apparatus 103 receives the broadcasting content and the first PPI (PPI_1) from the broadcasting contents transmitter 301.

The PPI generator 303 generates second PPI (PPI_2) in response to the purchase request of a user for a broadcasting content stored in the digital broadcasting contents receiving apparatus 103. The broadcasting contents transmitter 301 transmits the second PPI (PPI_2) to the digital broadcasting contents receiving apparatus 103. The broadcasting content for which the user made a purchase request is transmitted from the broadcasting contents transmitter 301 and stored in the digital broadcasting contents receiving apparatus 103. The second PPI (PPI_2) includes information on a changed distribution scope, which is different from the distribution scope information included in the first PPI (PPI_1), as mentioned in the above.

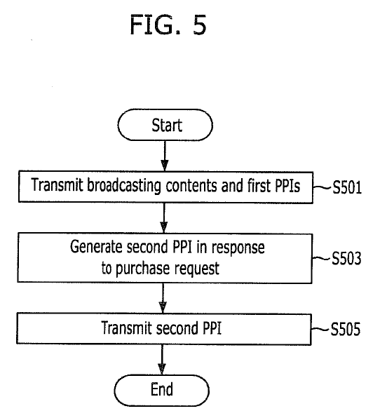

Although the above embodiments of the present invention have been described in the aspect of equipment, the operation of each constituent element forming the digital broadcasting contents transmitting apparatus and the digital broadcasting contents receiving apparatus may be easily figured out in the aspect of process. Therefore, the operations of the constituent elements included in the digital broadcasting contents transmitting apparatus and the digital broadcasting contents receiving apparatus may be understood as steps of a digital broadcasting contents transmitting method and a digital broadcasting contents receiving method. Hereafter, the digital broadcasting contents transmitting and receiving methods will be described with reference to FIGS. 4 and 5.

FIG. 4 is a flowchart describing a method for receiving a digital broadcasting, referred to as a digital broadcasting contents receiving method hereafter, in accordance with an embodiment of the present invention. Referring to FIG. 4, the digital broadcasting contents receiving method begins with receiving broadcasting contents and first PPIs (PPI_1) corresponding to the respective broadcasting contents in step S401.

In step S403, the received broadcasting contents are stored. Subsequently, in step S405, when there is a purchase request for a broadcasting content among the stored broadcasting contents, purchase request information corresponding to the purchase request is transmitted to the digital broadcasting contents transmitting apparatus 101. In step S407, second PPI (PPI_2) transmitted by the digital broadcasting contents transmitting apparatus 101 in response to the purchase request is received.

In step S409, the first PPI (PPI_1) is replaced with the second PPI (PPI_2). By doing so, the broadcasting content corresponding to the second PPI (PPI_2) may be permitted for external distribution.

In other words, the method of the present invention makes it possible to quickly and easily purchase a broadcasting content by storing predetermined broadcasting contents and replacing the PPI of a stored broadcasting content to be purchased.

Meanwhile, although not illustrated in the drawing, the digital broadcasting contents receiving method according to an embodiment of the present invention may further include receiving a program identifier. When there is a purchase request in the step S405, a program identifier corresponding to a broadcasting content a user wants to purchase may be transmitted to the digital broadcasting contents transmitting apparatus 101 to be requested for purchase. Herein, the user may select a broadcasting content to be purchased based on EPG.

FIG. 5 is a flowchart describing a method for transmitting a digital broadcasting, referred to as a digital broadcasting contents transmitting method hereafter, in accordance with an embodiment of the present invention. Referring to FIG. 5, the digital broadcasting contents transmitting method begins with transmitting broadcasting contents and first PPIs (PPI_1) corresponding to the respective broadcasting contents. The broadcasting contents and the first PPIs may be transmitted in the form of MPEG 2 transport stream and they may be received in the digital broadcasting contents receiving apparatus 103 and stored therein.

In step S503, second PPI (PPI_2) is generated in response to a purchase request for a broadcasting content stored in the digital broadcasting contents receiving apparatus 103. As described above, the second PPI (PPI_2) includes changed distribution scope information, which is different from the distribution scope information included in the first PPI (PPI_1).

In step S505, the second PPI (PPI_2) generated in the step S503 is transmitted to the digital broadcasting contents receiving apparatus 103.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media, that is, it includes not only tangible media such as CD and DVD, but also intangible media such as carrier wave.

According to the present invention, a digital broadcasting contents receiving apparatus purchases a broadcasting content by receiving and storing broadcasting contents, making a purchase request for the broadcasting content to be purchased which is stored in the digital broadcasting contents receiving apparatus, receiving PPI for the purchase-requested broadcasting content, and replacing existing PPI with the received PPI.

In this way, it is possible to quickly and easily purchase a broadcasting content without going through a separate procedure of acquiring permission from a copyright holder of the broadcasting content and downloading the broadcasting content.

While the present invention has been described with respect to the specific embodiments, it will be apparent to those skilled in the art that various changes and modifications may be made without departing from the spirit and scope of the invention as defined in the following claims.

What is claimed is:

1. An apparatus for receiving a digital broadcasting, comprising:
a broadcasting contents receiver configured to receive a broadcasting content and first program protection information (PPI) including distribution scope information of the broadcasting content;
a content storage configured to store the received broadcasting content;
a purchase requester configured to transmit purchase request information according to a purchase request of a user for the stored broadcasting content; and
a PPI controller configured to replace the first PPI with second PPI transmitted to the broadcasting contents receiver in response to the purchase request and including information on a changed distribution scope of the broadcasting content for which the purchase request is made.

2. The receiving apparatus of claim 1, wherein the broadcasting contents receiver further receives a program identifier corresponding to the broadcasting content, and
the purchase request of the user is made as the program identifier corresponding to the broadcasting content selected by the user based on electronic program guide (EPG) is transmitted to a broadcasting contents provider.

3. The receiving apparatus of claim 1, wherein each of the first PPI and the second PPI is based on a Redistribution Control (RC) descriptor of Advanced Television System Committee (ASTC), and
the second PPI includes a changed redistribution_control_code value, which is different from a redistribution_control_code value of the first PPI, in an RC descriptor of the ASTC and transmitted.

4. The receiving apparatus of claim 1, wherein the broadcasting content is transmitted in real-time according to a broadcasting schedule.

5. An apparatus for transmitting a digital broadcasting, comprising:
a broadcasting contents transmitter configured to transmit a broadcasting content and first program protection information (PPI) including distribution scope information of the broadcasting content; and
a PPI generator configured to generate second PPI to be transmitted by the broadcasting contents transmitter and including information on a changed distribution scope of the broadcasting content for which a purchase request is made by a user, in response to the purchase request of the user for the broadcasting content stored in a digital broadcasting contents receiving apparatus.

6. An method for receiving a digital broadcasting, comprising:
receiving a broadcasting content and first program protection information (PPI) including distribution scope information of the broadcasting content;
storing the received broadcasting content;
transmitting purchase request information according to a purchase request of a user for the stored broadcasting content;
receiving second PPI transmitted and transmitted in response to the purchase request and including information on a changed distribution scope of the broadcasting content for which the purchase request is made; and
replacing the first PPI with the second PPI.

7. The receiving method of claim 6, further comprising:
receiving a program identifier corresponding to the broadcasting content,
wherein said transmitting purchase request information includes providing a broadcasting contents provider with the program identifier corresponding to the broadcasting content selected by the user based on electronic program guide (EPG).

8. The receiving method of claim 6, wherein each of the first PPI and the second PPI is based on a Redistribution Control (RC) descriptor of Advanced Television System Committee (ASTC), and
the second PPI includes a changed redistribution_control_code value, which is different from a redistribution_control_code value of the first PPI, in an RC descriptor of the ASTC and transmitted.

9. The receiving method of claim 6, wherein the broadcasting content is transmitted in real-time according to a broadcasting schedule.

10. A method for transmitting a digital broadcasting, comprising:
transmitting a broadcasting content and first program protection information (PPI) including distribution scope information of the broadcasting content;
generating second PPI including information on a changed distribution scope of the broadcasting content for which a purchase request is made by a user, in response to the purchase request of the user for the broadcasting content stored in a digital broadcasting contents receiving apparatus; and
transmitting the second PPI.
